(19) United States
(12) Patent Application Publication
(10) Pub. No.: US 2026/0150993 A1
(43) Pub. Date: Jun. 4, 2026

(54) COOKING SYSTEM

(71) Applicant: StoreBound LLC, New York, NY (US)

(72) Inventors: Evan Marc Dash, New York, NY (US); Alexander Ogof, Brooklyn, NY (US); Qiyuan Dou, Shenzhen (CN); Cheng Zhao, Shenzhen (CN); Yiyang Zhang, Shenzhen (CN)

(73) Assignee: StoreBound LLC, New York, NY (US)

(21) Appl. No.: 19/390,779

(22) Filed: Nov. 17, 2025

Related U.S. Application Data
(60) Provisional application No. 63/726,881, filed on Dec. 2, 2024.

(51) Int. Cl. A47J 27/12; A47J 27/00

(52) U.S. Cl. CPC A47J 27/12; A47J 27/002; A47J 2201/00

(57) ABSTRACT

A cooking system includes a cooking unit and a plurality of cooking vessels. The cooking unit may have a cooking surface. The plurality of cooking vessels may include at least a first cooking vessel having a first cavity and a second cooking vessel. The cooking system may be alterable between a storage state and one or more cooking states. In the cooking states, any one of the plurality of cooking vessels may be located atop of the cooking surface of the cooking unit to cook food contained therein. In the storage state, the cooking unit and the second cooking vessel may be located within the first cavity of the first cooking vessel, with the cooking unit located between the second cooking vessel and a floor of the first cavity of the first cooking vessel.

### CROSS-REFERENCE TO RELATED PATENT APPLICATIONS

The present application claims the benefit of priority to United States Provisional Patent Application Ser. No. 63/726,881, filed Dec. 2, 2024, the entirety of which is incorporated herein by reference.

### BACKGROUND OF THE INVENTION

Professional and home chefs alike continually struggle with reducing countertop clutter and maintaining an aesthetically pleasing kitchen while striving to preserve the functionality of the kitchen. Electric appliances have been in use for some time, which allow a user to store the appliance in a cabinet when not in use, thereby freeing up countertop space. A need exists for a cooking system with increased storage options that maximizes cooking capabilities while minimizing storage requirements.

### BRIEF SUMMARY OF THE INVENTION

A cooking system may include a cooking unit and a plurality of cooking vessels. The cooking unit and cooking vessels may be placed into a stacked arrangement for storage. In such a stacked arrangement, the cooking unit may be placed inside of the largest of the cooking vessels, and then the remaining cooking vessels may be stacked. In the stacked arrangement, the largest vessel may be visible along with upper portions of the remaining cooking vessels, but the cooking unit may be hidden from view within the cavity of the largest cooking vessel.

In one aspect, the invention may be a cooking system comprising: a cooking unit comprising a cooking surface; a plurality of cooking vessels comprising: a first cooking vessel comprising a first cavity having a first volume; a second cooking vessel comprising a second cavity having a second volume that is less than the first volume; wherein in a cooking state, any one of the plurality of cooking vessels is configured to be placed atop of the cooking surface of the cooking unit and heated by the cooking unit; and wherein in a storage state, the cooking unit and the second cooking vessel are at least partially positioned within the first cavity of the first cooking vessel with the cooking unit located between the second cooking vessel and a floor of the first cavity of the first cooking vessel.

In another aspect, the invention may be a cooking system comprising: a cooking unit comprising a cooking surface; a plurality of cooking vessels comprising: a first cooking vessel comprising a first cavity; a second cooking vessel comprising a second cavity; and a third cooking vessel comprising a third cavity; wherein the cooking system is alterable between a storage state and a cooking state; wherein in the storage state, the cooking unit and the plurality of cooking vessels are in a stacked arrangement whereby the cooking unit is located entirely within the first cavity of the first cooking unit, the second cooking vessel is supported by the first cooking vessel with at least a majority of the second cooking vessel located within the first cavity of the first cooking vessel, and the third cooking vessel is supported by the second cooking vessel and is at least partially positioned within the second cavity of the second cooking unit; and wherein in the cooking state, the cooking unit is positioned atop of a support surface and any one of the plurality of cooking units is positioned atop of the cooking surface of the cooking unit for heating by the heating unit.

In yet another aspect, the invention may be a cooking system comprising: a cooking unit comprising: a cooking plate comprising a cooking surface and a through-hole; and a thermostat that is located within the through-hole of the cooking plate, the thermostat being alterable between an extended state wherein at least a portion of the thermostat protrudes from the cooking surface of the cooking plate and a retracted state wherein a top surface of the thermostat is flush with the cooking surface of the cooking plate, and wherein the thermostat is biased into the extended state by a spring member; a plurality of cooking vessels comprising: a first cooking vessel comprising a first cavity; and a second cooking vessel; wherein in a storage state, the cooking unit and the second cooking vessel are at least partially positioned within the first cavity of the first cooking vessel with the cooking unit located between the second cooking vessel and a floor of the first cavity of the first cooking vessel, a bottom surface of the cooking vessel being maintained spaced from the cooking surface of the cooking unit, and the thermostat being in the extended state; and wherein in a cooking state, any one of the plurality of cooking vessels is configured to be placed atop of the cooking surface of the cooking unit, thereby altering the thermostat from the extended state to a retracted state whereby a top surface of the thermostat is flush with the cooking surface of the cooking plate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a cooking system in a storage state in accordance with an embodiment of the present invention;

FIG. 2 is a perspective view of the cooking system in an unstacked or exploded arrangement;

FIG. 3A is a top perspective view of a cooking unit of the cooking system of FIG. 1;

FIG. 3B is a bottom perspective view of the cooking unit of FIG. 3A;

FIG. 3C is a front view of the cooking unit of FIG. 3A;

FIG. 4 is an exploded view of the cooking unit of FIG. 3A;

FIG. 5 is a cross-sectional view taken along line V-V of FIG. 3C;

FIG. 6A is a cross-sectional view of the cooking unit of FIG. 3A illustrating a thermostat member thereof in an extended state;

FIG. 6B is a cross-sectional view of the cooking unit of FIG. 3A illustrating the thermostat member thereof in a retracted state;

FIG. 7A is a perspective view illustrating a first cooking vessel of the cooking system positioned on a cooking surface of the cooking unit in a cooking state;

FIG. 7B is a cross-sectional view taken along line VIIB-VIIB of FIG. 7A;

FIG. 8A is a perspective view illustrating a second cooking vessel of the cooking system positioned on the cooking surface of the cooking unit in a cooking state;

FIG. 8B is a perspective view illustrating a third cooking vessel of the cooking system positioned on the cooking surface of the cooking unit in a cooking state;

FIG. 8C is a perspective view illustrating a fourth cooking vessel of the cooking system positioned on the cooking surface of the cooking unit in a cooking state;

FIG. 9A illustrates the cooking unit being placed into the cavity of the first cooking vessel;

FIG. 9B illustrates the second cooking vessel being placed into the cavity of the first cooking vessel after the cooking unit;

FIG. 9C illustrates the third cooking vessel being placed into a cavity of the second cooking vessel;

FIG. 9D illustrates the fourth cooking vessel being placed into a cavity of the third cooking vessel;

FIG. 9E illustrates a first lid of the cooking system being placed atop of the fourth cooking vessel;

FIG. 9F illustrates a second lid of the cooking system being placed atop of the first lid;

FIG. 9G illustrates the cooking system in the storage state with all of the components thereof in a stacked arrangement; and

FIG. 10 is a cross-sectional view taken along line X-X of FIG. 9G.

### DETAILED DESCRIPTION OF THE INVENTION

The following description of the preferred embodiment(s) is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

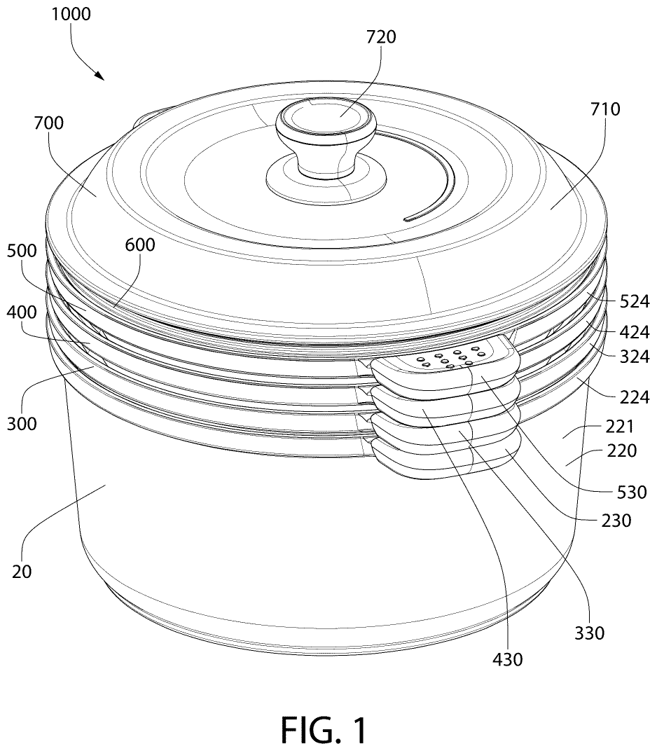

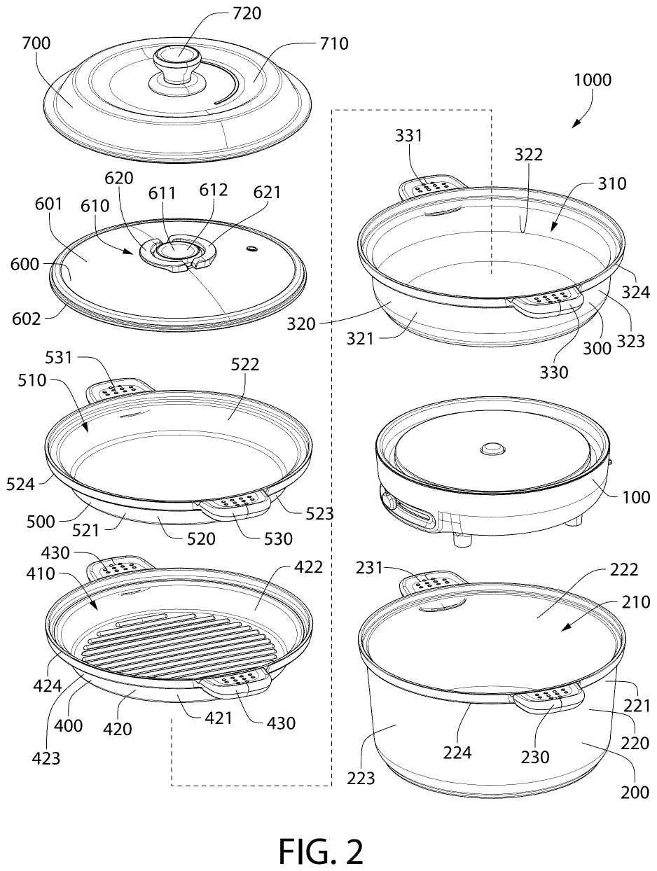

Referring to FIGS. 1 and 2, a cooking system 1000 is illustrated in accordance with an embodiment of the present invention. FIG. 1 illustrates the cooking system 1000 in a storage state (i.e., in a stacked arrangement). FIG. 2 illustrates the cooking system 1000 in an exploded state whereby each component or distinct piece of the cooking system 1000 is visible. The cooking system 1000 may comprise a cooking unit 100, a plurality of cooking vessels including a first cooking vessel 200, a second cooking vessel 300, a third cooking vessel 400, and a fourth cooking vessel 500, a first lid 600, and a second lid 700.

While four cooking vessels 200, 300, 400, 500 are shown in the exemplified embodiment, fewer or greater than four cooking vessels could be used in other embodiments. For example, the system 1000 may include only the first and second cooking vessels 200, 300, the system 1000 may include only the first, second, and third cooking vessels 200, 300, 400, or the system 1000t may include more than the four cooking vessels (e.g., five cooking vessels, six cooking vessels, etc.). In the exemplified embodiment, the first cooking vessel 200 comprises a first cavity 210 having a first volume, the second cooking vessel 300 comprises a second cavity 310 having a second volume, the third cooking vessel 400 comprises a third cavity 310 having a third volume, and the fourth cooking vessel 500 comprises a fourth cavity 410 having a fourth volume. The first volume may be greater than the second volume. The second volume may be greater than the third volume. The third volume may be greater than the fourth volume. Alternatively, the third and fourth volumes may be substantially the same (substantially meaning within 5%).

In an embodiment, each of the first, second, third, and fourth cooking vessels 200, 300, 400, 500 may be formed from metal. In an embodiment, each of the first, second, third, and fourth cooking vessels 200, 300, 400, 500 may be formed from aluminum. Alternatively, the cooking vessels 200, 300, 400, 500 may be formed from ceramic or other materials commonly used for cooking. The first and second cooking vessels 200, 300 may be pots or skillets. The third cooking vessel 400 may be a grill pan. The fourth cooking vessel 500 may be a griddle pan. Of course, the exact style and type of the various pots, pans, and other cooking vessels used in accordance with the inventive concepts described herein is not to be limited to the specific exemplary embodiment as shown in the drawings.

The first cooking vessel 200 comprises a body portion 220 comprising a body portion sidewall 221 having an inner surface 222 and an outer surface 223 and a rim 224 that protrudes from the outer surface 223 of the body portion sidewall 221 at a top end of the body portion sidewall 221. Furthermore, the first cooking vessel 200 comprises a first handle 230 protruding from the rim 224 and a second handle 231 protruding from the rim 224. The first and second handles 230, 231 may be circumferentially spaced apart by approximately 180°. Further details of the first and second handles 230, 231 will be provided below.

The second cooking vessel 300 comprises a body portion 320 comprising a body portion sidewall 321 having an inner surface 322 and an outer surface 323 and a rim 324 that protrudes from the outer surface 323 of the body portion sidewall 321 at a top end of the body portion sidewall 321. Furthermore, the second cooking vessel 300 comprises a first handle 330 protruding from the rim 324 and a second handle 331 protruding from the rim 324. The first and second handles 330, 331 may be circumferentially spaced apart by approximately 180°.

The third cooking vessel 400 comprises a body portion 420 comprising a body portion sidewall 421 having an inner surface 422 and an outer surface 423 and a rim 424 that protrudes from the outer surface 423 of the body portion sidewall 421 at a top end of the body portion sidewall 421. Furthermore, the third cooking vessel 400 comprises a first handle 430 protruding from the rim 424 and a second handle 431 protruding from the rim 424. The first and second handles 430, 431 may be circumferentially spaced apart by approximately 180°.

The fourth cooking vessel 500 comprises a body portion 520 comprising a body portion sidewall 521 having an inner surface 522 and an outer surface 523 and a rim 524 that protrudes from the outer surface 523 of the body portion sidewall 521 at a top end of the body portion sidewall 521. Furthermore, the fourth cooking vessel 500 comprises a first handle 530 protruding from the rim 524 and a second handle 531 protruding from the rim 524. The first and second handles 530, 531 may be circumferentially spaced apart by approximately 180°.

As shown in FIG. 1 and described in more detail below, when the various cooking vessels are stacked in the storage state, each of the handles of each upper cooking vessel in the stack nests within a depression formed in one of the handles in the immediately adjacent lower cooking vessel in the stack. The handles of the upper cooking vessels may also rest atop of the top edge of the rim of the immediately adjacent lower cooking vessel.

In an embodiment, the first lid 600 may be formed from a first material and the second lid 700 may be formed from a second material that is different from the first material. In an embodiment, the first lid 600 may be formed from glass and the second lid 700 may be formed from metal such as aluminum and/or ceramic.

In the exemplified embodiment, the first lid 600 may be formed at least partially from glass. Specifically, the first lid 600 may comprise a lid base 601 formed from glass and a lid edge 602 formed from an elastomeric material such as silicone. The lid edge 602 may form an annular structure located along a peripheral edge of the lid base 601. The first lid 600 may further comprise a knob 610. The knob 610 may comprise a hub portion 611 that is coupled to the lid base 601. The hub portion 611 may comprise a top surface 612. The knob 610 may further comprise a first gripping member 620 that is pivotably coupled to the hub portion 611 and a second gripping member 621 that is pivotably coupled to the hub portion 611. The first and second gripping members 620, 621 may comprise posts that nest within recesses or holes in the hub portion 611 to facilitate the pivoting or rotation of the first and second griping members 620, 621 relative to the hub portion 611. The first and second gripping member 620, 621 may be pivotable between a first position, shown in FIG. 2, wherein no portion of the first and second gripping members 620, 621 protrudes beyond the top surface 512 of the hub portion 611 and a second position (not shown) wherein the first and second griping members 620, 620 protrude beyond the top surface 612 of the hub portion 611.

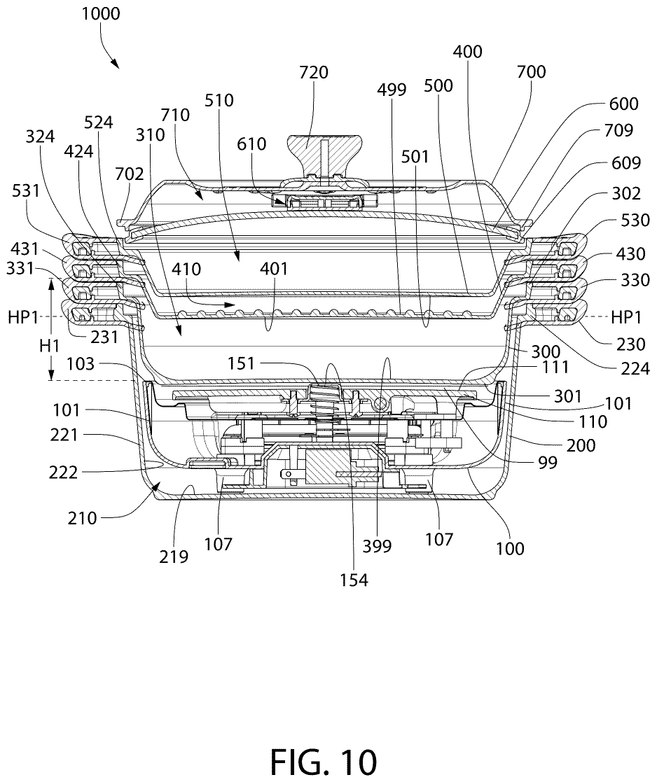

The first and second gripping members 620, 621 may each be U-shaped. The first and second gripping members 620, 621 may each have an inner surface. In the first position as shown in FIG. 2, the inner surface of the first gripping member 620 may surround a first portion of a side surface of the hub portion 611 and the inner surface of the second gripping member 621 may surround a second portion of the side surface of the hub portion 611. In the second position, each of the first and second gripping members 620, 621 may protrude above the top surface 612 of the hub portion 611 to define a space between the inner surfaces of the first and second gripping members 620, 621 and the top surface 612 of the hub portion 611. The space may be configured to receive a user's fingers to facilitate movement of the first lid 600. By allowing the first and second griping members 620, 621 to pivot into the flat state (i.e., first position), the knob 610 may nest comfortably within the interior of the second lid 700 when all of the components are stacked together (see, for example, FIG. 10). Then, by allowing the first and second gripping members 620, 621 to pivot into the second position, a user can readily manipulate the first lid 600 while avoiding contact with any hot surfaces thereof.

The second lid 700 may comprise a main body portion 710 and a knob 720. The second lid 700 may be formed by casting. The knob 720 may be cast separately from the main body portion 710 and may be affixed thereto with a fastener such as a screw. Alternatively, the main body portion 710 and the knob 720 may be formed as a monolithic structure.

As seen in FIG. 1, when the components are stacked in the storage state, no portion of the cooking unit 100 is visible. Thus, the cooking system 1000 appears to be simply a set of stacked pots and pans. This is because the cooking unit 100 is located within the first cavity 210 of the first cooking vessel 200 and is then covered by the second cooking vessel 300 which is also located within the first cavity 210 of the first cooking vessel 200. As will be discussed in more detail below, the cooking unit 100 is located within the first cavity 210 of the first cooking vessel 200 when the system 1000 is in the storage state, and then the second cooking vessel 300 is positioned in the first cavity 210 of the first cooking vessel 200 above the cooking unit 100. The cooking unit 100 is located within the first cavity 210 of the first cooking vessel 200 between a bottom end of the second cooking vessel 300 and a floor of the first cavity 210 of the first cooking vessel 200. As such, the cooking unit 100 is hidden from view beneath the second coking vessel 300. Looking just at FIG. 1, when the system 1000 is in the storage state, there is no indication that the system 1000 even includes the cooking unit 100. This would be true even if only the cooking unit 100 and the second cooking vessel 300 were stacked within the first cavity 210 of the first cooking vessel 200 without the other cooking vessels and the lids. The various components of the system 1000 stack seamlessly while keeping the cooking unit 100 hidden from view until the various components are unstacked such as when being used for cooking as described herein.

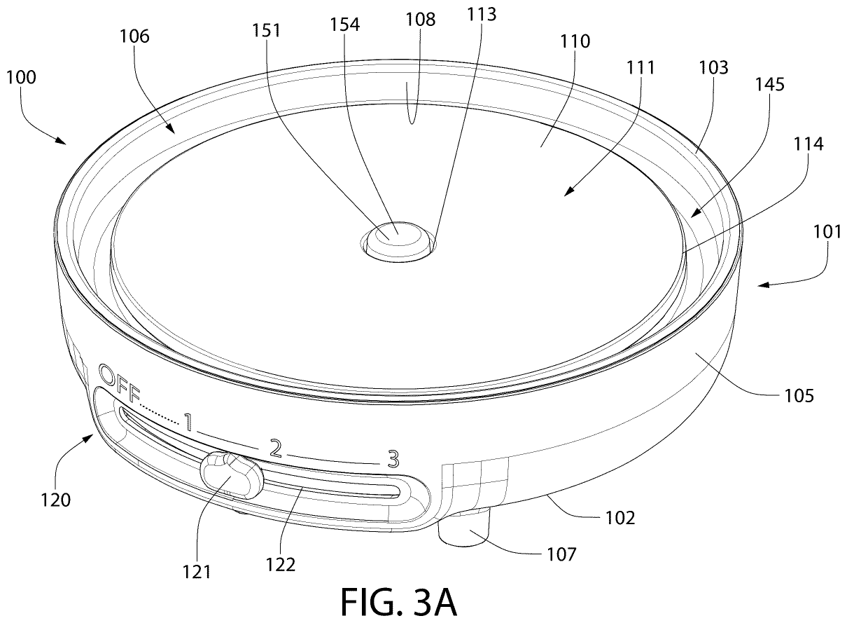

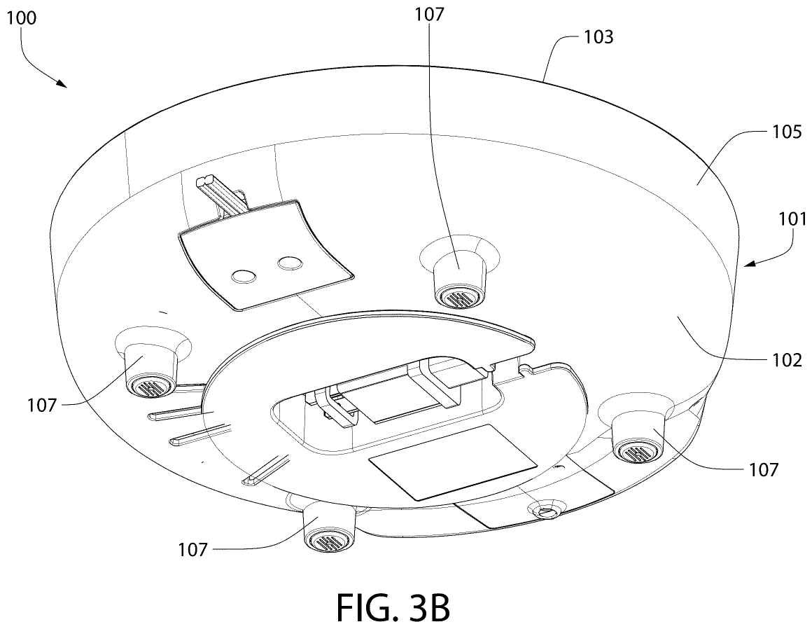

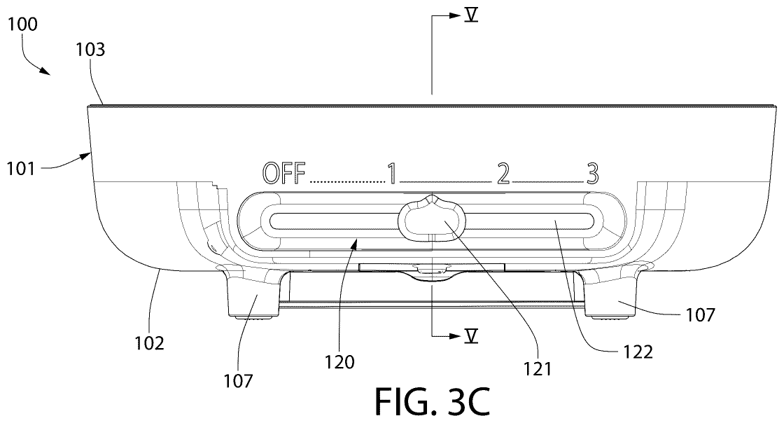

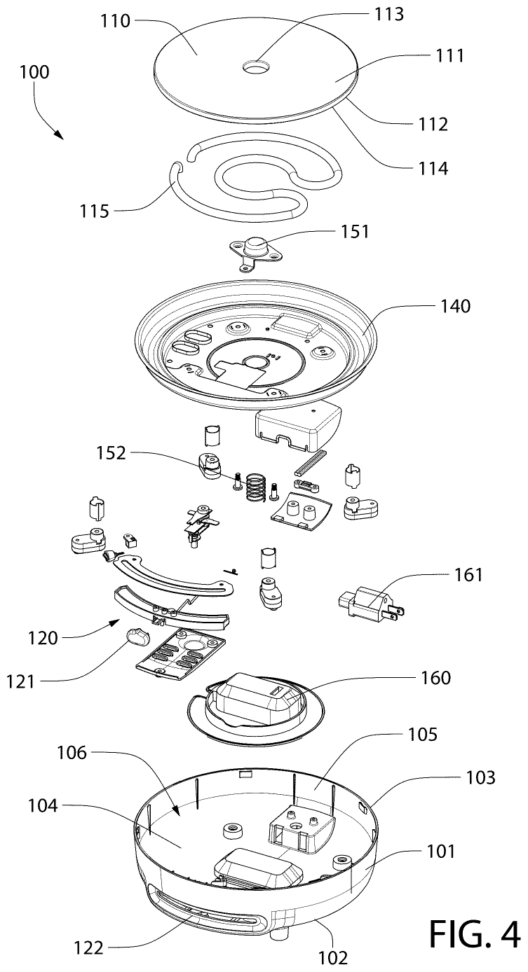

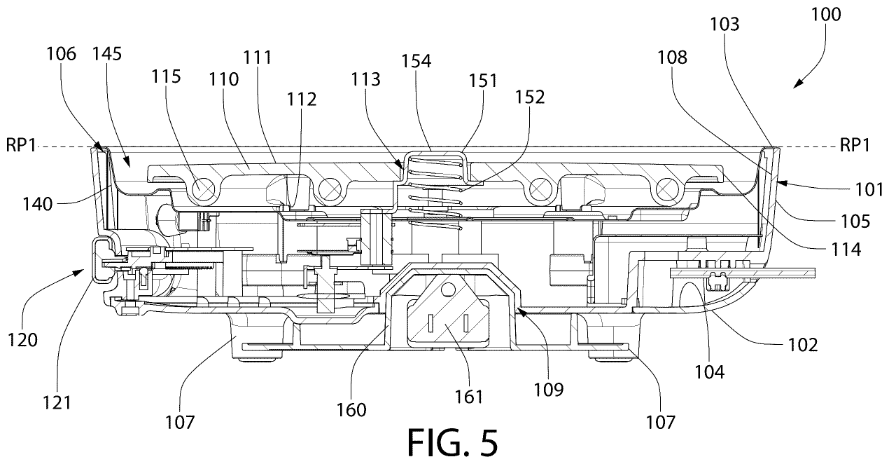

Referring to FIGS. 3A-3C, the cooking unit 100 will be described. FIGS. 3A-3C will be used to describe the external features of the cooking unit 100. The interior components of the cooking unit 100 will be described after with reference to FIGS. 4 and 5.

The cooking unit 100 comprises a cooking unit housing 101 comprising a bottom end 102 and a top end 103. The cooking unit housing 101 comprises a cooking unit floor 104 (see, for example, FIG. 5) and a cooking unit sidewall 105. The cooking unit floor 104 and the cooking unit sidewall 105 collectively define a cooking unit cavity 106. The cooking unit sidewall 105 may comprise an inner surface that faces and/or bounds the cooking unit cavity 106. The cooking unit 100 may comprise a plurality of support legs 107 that are configured to support the cooking unit 100 on a support surface such as a countertop, a table, or the like during use. The plurality of legs 107 may protrude from the bottom end 102 of the cooking unit housing 101.

The cooking unit 100 may comprise a cooking plate 110 having a top surface 111 and a bottom surface 112 (best shown in FIG. 5) opposite the top surface 110. The top surface 111 of the cooking plate 110 may form a cooking surface of the cooking unit 100. That is, the various cooking vessels 200, 300, 400, 500 described herein may be placed atop of the top surface 111 (i.e., cooking surface) of the cooking plate 110 to facilitate cooking of food contained in the specific cooking vessel. The cooking plate 110 may be heated by a heating element as described below to thereby heat the food located in the cooking vessel placed thereon during use. The cooking plate 110 may comprise a through-hole 113. The through-hole 113 may be located at a center of the cooking plate 110. The through-hole 113 may extend through the thickness of the cooking plate 110 from the top surface 111 to the bottom surface 112. The through-hole 113 is circular in the exemplified embodiment, but other shapes may be used in other embodiments.

The cooking unit 100 may comprise a thermostat member 151 that is located within the through-hole 113. The thermostat member 151 may be biased by a spring into an extended state whereby the thermostat member 151 protrudes from/beyond the top surface (i.e., cooking surface) 111 of the cooking plate 110. In the extended state, a top surface 154 of the thermostat member 151 may be elevated above the top surface 111 of the cooking plate 110. The thermostat member 151 may be altered from the extended state to a retracted state whereby the thermostat member 151 is retracted into the through-hole 113. The thermostat member 151 may be altered into the retracted state when a weight, such as one of the cooking vessels described herein (or any other cooking vessel as desired by a user) is located on the top surface 111 of the cooking plate 110. The weight of the cooking vessel may cause the thermostat member 151 to retract so that the top surface 154 of the thermostat member 151 is flush with the top surface 111 of the cooking plate 110 and remains in contact with a lower or bottom surface of the cooking vessel to monitor/detect the temperature of the cooking vessel during use.

The cooking unit 100 may comprise a cooking adjustment actuator 120 that is configured to alter the cooking unit 100 from an off state to any of one or more on states. In the exemplified embodiment, the cooking adjustment actuator 120 comprises a slider member 121 that slides within a slot 122 formed into the cooking unit housing 101. The left-most position of the slider 121 may be an “OFF” state of the cooking unit 100 whereby no heat is generated or whereby the cooking unit 100 is otherwise not capable of heating food in one of the cooking vessels 200, 300, 400, 500 placed thereon. The slider 121 may be configured to slide to a position that is aligned with one of the numerals 1, 2, or 3 as shown above the slider member 121 in the provided figures. When the slider 121 is aligned with the numeral 1, the cooking unit 100 may be altered into a low heat cooking state, when the slider 121 is aligned with the numeral 2 the cooking unit 100 may be altered into a medium heat cooking state, and when the slider 121 is aligned with the numeral 3 the cooking unit 100 may be altered into a high heat cooking state.

The cooking adjustment actuator 120 may take on other forms in other embodiments. In an embodiment, the cooking unit 100 may comprise a display with a user interface that enables a user to interact with the display to alter the properties or characteristics of the cooking unit 100. For example, the user can alter the mode, temperature, time, or the like on such a display and user interface. In another embodiment, the cooking adjustment actuator 120 may comprise a knob that a user may turn to alter the cooking unit 100 between the various cooking states and off states. In still other embodiments, the cooking adjustment actuator may comprise up and down arrow buttons and/or other buttons to enable a user to adjust the mode, temperature, time, or the like. Thus, there are many different possibilities for the specific details of the cooking adjustment actuator 120. In any case, the cooking adjustment actuator 120 forms a user operable device that enables a user to alter the cooking unit 100 between an off state and one or more on states as described.

Referring to FIGS. 3A, 4, and 5, the cooking unit 100 will be described in more detail. The cooking plate 110 comprises a peripheral surface or peripheral edge 114 that extends between the top and surfaces 111, 112 of the cooking plate 110. In the exemplified embodiment, the peripheral edge 114 of the cooking plate 110 is spaced radially inward of an inner surface 108 of the cooking unit sidewall 105. Moreover, the cooking unit 100 may comprise an insulation insert 140 located within the cooking unit cavity 106, and the cooking plate 110 may nest within an interior cavity of the insulation insert 140. In such embodiment, the peripheral edge 114 of the cooking plate 110 may be spaced radially inward of an inner surface of the insulation insert 140. In either situation, there may be an annular gap 145 between the peripheral edge 114 of the cooking plate 110 and the inner surface 108 of the cooking unit sidewall 105 (or the inner surface of the insulation insert 140). The annular gap 145 may be a continuous annular gap extending around an entirety of the peripheral edge 114 of the cooking plate 110.

The cooking unit 100 may comprise a heating element 115 that is coupled to the heating plate 110. The heating element 115 may be configured to generate heat when powered. The heating element 115 may transfer its generated heat to the heating plate 110 via conduction due to the contact between the heating element 115 and the cooking plate 110. The heating element 115 may be embedded within a channel of the cooking plate 110 or may be otherwise placed into contact with the cooking plate 110 to transfer the heat generated thereby. The heating element 115 may be a conventional electric heating element that converts electric energy into heat, such as one comprising a heating resistor and accessories. In other embodiments, the cooking unit 100 may generate heat by induction. In such embodiments, the heating element 115 may be an induction heater comprising an electromagnet and an electronic oscillator.

The cooking unit 100 may further comprise a locking mechanism. The locking mechanism may be alterable from a locked state to an unlocked state. The locking mechanism may be biased into the locked state, meaning that the locking mechanism is normally in the locked state unless altered into the unlocked state as described herein. The locking mechanism may prevent the operation of the cooking unit 100, and specifically the heating of the heating element 115, until the locking mechanism is altered into unlocked state. In some embodiments, the locking mechanism may be automatically altered from the locked state to an unlocked state when a cooking vessel is supported on the cooking surface of the cooking plate 110. Thus, in some embodiments when one of the cooking vessels 200, 300, 400, 500 is placed onto the cooking plate 110 so that the weight of the cooking vessel 200, 300, 400, 500 is supported by the cooking plate 110, the locking mechanism is altered from the locked state (into which it is biased when no load is applied) whereby the cooking unit 100 cannot be powered on or activated to the unlocked state whereby the cooking unit 100 can be powered on or activated.

In the exemplified embodiment, the cooking unit 100 comprise the thermostat member 151 and a spring member 152 that are operably coupled together. The thermostat member 151 may be operably coupled to the heating element 115. The thermostat member 151 may detect and monitor a temperature of a cooking vessel located on the cooking plate 110. Based on the temperature of the cooking vessel, the thermostat member 151 may control the activation/deactivation of the heating element 115 to maintain the temperature of the cooking vessel in a desired range depending on the heat setting from the cooking adjustment actuator 120. In an embodiment, the thermostat member 151 and the heating element 115 may both be operably coupled to a processor that facilitates the temperature adjustments.

As mentioned above, the thermostat member 151 may be located within the through-hole 113 of the cooking plate 110. The spring member 152 may be a compression spring, although other types of springs may be used in other embodiments, including, for example without limitation, conical springs, spiral springs, disc springs, etc. When no load is applied onto the spring member 152, the thermostat member 151 may be in the extended state such that at least a portion of the thermostat member 151 protrudes from and beyond the top surface 111 (the cooking surface) of the cooking plate 110. The top surface 154 of the thermostat member 151 may be recessed relative to a reference plane RP1 on which the top end 103 of the cooking unit 100 lies. Thus, the top surface 154 of the thermostat 151 may not protrude beyond the top end 103 of the cooking unit 100, but may protrude from/beyond the top surface 111 of the cooking plate 110.

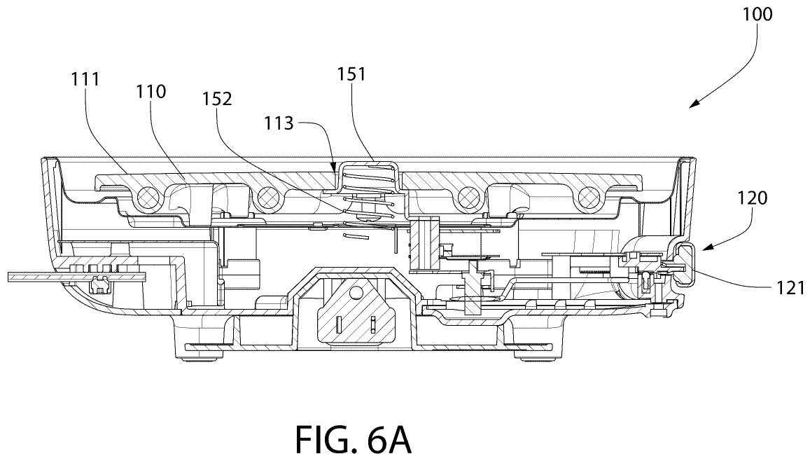

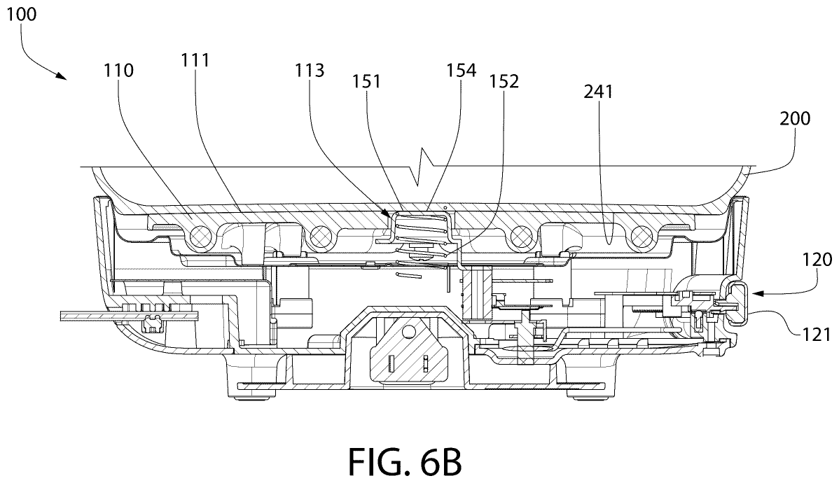

Referring to FIG. 6A, the thermostat member 151 is illustrated in the extended state. In the extended state, the thermostat member 151 protrudes from/beyond the top surface 111 of the cooking plate 110. In FIG. 6B, the first cooking vessel 200 is located atop of the cooking surface of the cooking plate 110. While FIG. 6B illustrates the function of the thermostat member 151 with the first cooking vessel 200, any one of the first, second, third, and fourth cooking vessels 200, 300, 400 500 could be used. When the first cooking vessel 200 (or any of the other cooking vessels 300, 400, 500) is placed atop of the top surface 111 (i.e., the cooking surface) of the cooking plate 110, the weight of the first cooking vessel 200 atop of the thermostat member 151 forces the compression of the spring member 152, which causes the thermostat member 151 to retract into the through-hole 113. When the thermostat member 151 is in the retracted state, the top surface 154 of the thermostat member 151 may be flush with the top surface (i.e., cooking surface) 111 of the cooking plate 110. Furthermore, when the first cooking vessel 200 is placed atop the top surface 111 of the cooking plate 110, the top surface 154 of the thermostat member 151 is in surface contact with a bottom surface 241 of the first cooking vessel 200. Furthermore, the spring member 152 continues to apply a spring force onto the thermostat member 151 thereby pressing the top surface 154 of the thermostat member 151 into forcible surface contact with the bottom surface 241 of the first cooking vessel 200. This ensures that the thermostat member 151 is able to monitor and detect the temperature of the first cooking vessel 200 during use.

Turning once again to FIGS. 4 and 5, there are additional components of the cooking unit 100 not previously mentioned. Many of these additional components are various covers, housings, fasteners, and the like that are part of the overall unit and will not be described herein due to their de minimis nature. However, one component worth mentioning is a power cord housing 160 that is coupled to the bottom end 102 of the cooking unit housing 101 to hold and store the power cord or plug 161 when the cooking unit 100 is not in use. The bottom surface 102 of the cooking unit housing 100 may comprise a bottom surface cavity 109 and the power cord housing 160 may be coupled to the cooking unit housing 101 at least partially within the bottom surface cavity 109.

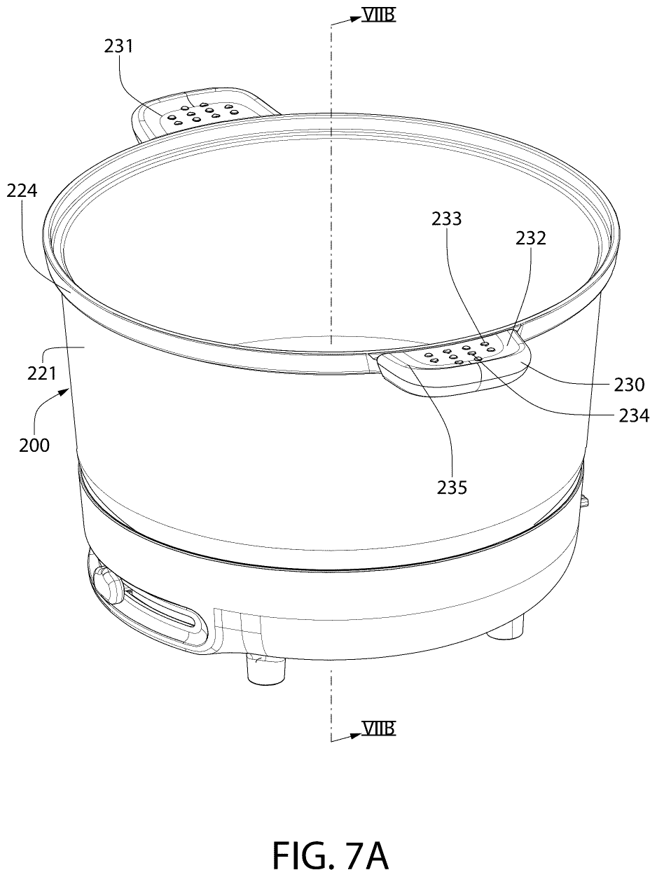

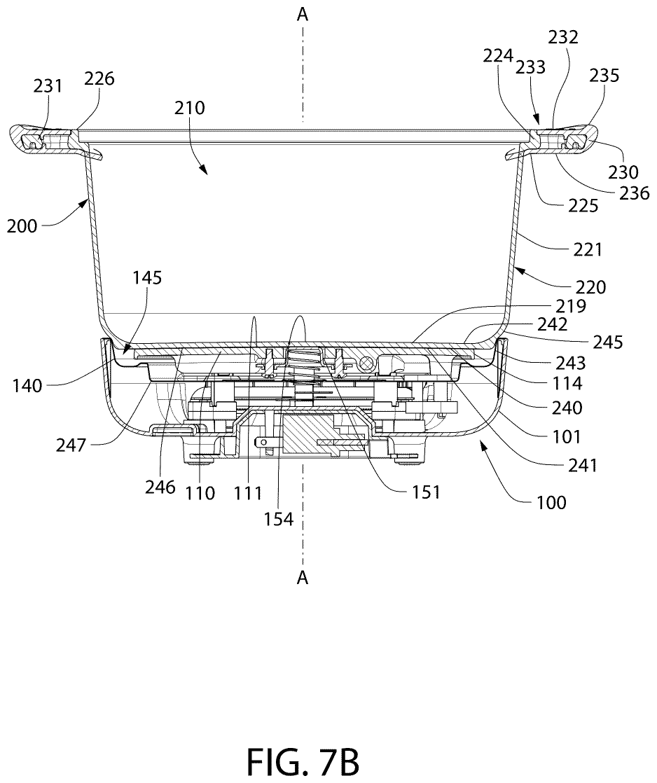

Referring to FIGS. 7A and 7B, the cooking system 1000 will be described in a cooking state whereby the first cooking vessel 200 is placed top of the cooking surface (i.e., the top surface 111) of the cooking plate 110 of the cooking unit 100. Even though the cooking unit 100 is capable of being wholly inserted into the first cavity 210 of the first cooking vessel 200, the first cooking vessel 200 is also capable of being placed atop of the cooking surface of the cooking unit 100 to cook or heat food contained therein.

The first cooking vessel 200 comprises the body portion 220 that comprises the body portion sidewall 221 and the rim 224 as previously described. Thus, the rim 224 has a lower rim surface 225 that protrudes from the outer surface 223 of the body portion sidewall 221. The rim 224 also has an upper rim surface 226 that forms a top-most end of the first cooking vessel 200. The rim 224 protrudes radially outwardly from the top end of the body portion sidewall 221. The first and second handles 230, 231 are coupled to the first cooking vessel 200 at the rim 224 and extend radially outward therefrom. The first and second handles 230, 231 are identical, although some details will now be described with reference to the first handle 230. Furthermore, the handles of the other cooking vessels 300, 400, 500 may also be identical to the first and second handles 230, 231 of the first cooking vessel 200.

The first handle 230 comprises a top surface 232 having a top surface depression 233. The first handle 230 may comprise protuberances 234 located on the top surface 232 within the top surface depression 233. The top surface 232 may have a peripheral portion 235 that surrounds the top surface depression 233 and that is angled upwardly from the top surface depression 233. The first handle 230 further comprises a bottom surface 236 opposite the top surface 233. The bottom surface 236 of the first handle 230 extends over and covers a portion of the lower rim surface 225 of the rim 224. The bottom surface 236 is planar along most, if not all, of its length.

The first cooking vessel 200 further comprises a bottom portion 240 that comprises a bottom surface 241 of the first cooking vessel 200 and a top surface 242 that forms the floor 219 of the first cavity 210 of the first cooking vessel 200. The bottom portion 240 further comprises a bottom portion sidewall 243. The first cooking vessel 200 further comprises a curved transition portion 245 that extends between the bottom portion sidewall 243 and the body portion sidewall 220. The first cavity 210 of the first cooking vessel 200 comprises a first cavity axis A-A. In the exemplified embodiment, the outer surface 223 of the body portion sidewall 221 is angled outwardly in a direction away from the first cavity axis A-A. Stated another way, the body portion sidewall 221 is tapered inwardly moving in a direction from the top opening of the first cavity 210 towards the floor of the first cavity 210.

When the first cooking vessel 200 is placed atop of the cooking plate 110 of the cooking unit 100, a central portion 246 of the bottom surface 241 of the bottom portion 240 of the first cooking vessel 200 is in direct contact with the top surface 111 of the cooking plate 110 and an outer annular portion 247 of the bottom surface 241 of the bottom portion extends radially beyond the peripheral edge 114 of the cooking plate 110 and into the annular gap 145 between the peripheral edge 114 of the cooking plate 110 and the cooking unit housing 101. An upper edge of the insulation insert 140 nests adjacent to the curved transition portion 245. In an embodiment, the upper edge of the insulation insert 140 nests within a small concave section between the bottom portion sidewall 243 and the curved transition portion 245. In an embodiment, the upper edge of the insulation insert 140 may be in direct contact with the curved transition portion 245 of the first cooking vessel 200. The shapes of the cooking unit 100 and the first cooking vessel 200 allows for the cooking unit 100 to be placed into the first cavity 210 of the first cooking vessel 200 while also permitting the first cooking vessel 200 to rest atop of the cooking surface of the cooking unit 100. As shown in FIG. 7B, the weight of the first cooking vessel 200 alter the thermostat member 151 into the retracted state while the top surface 154 of the thermostat member 151 remains in surface contact with the bottom surface 241 of the first cooking vessel 200.

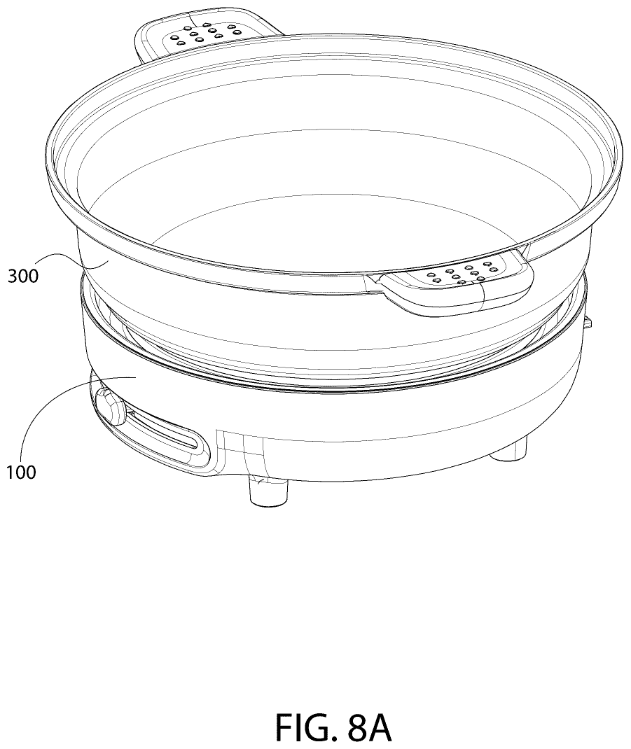

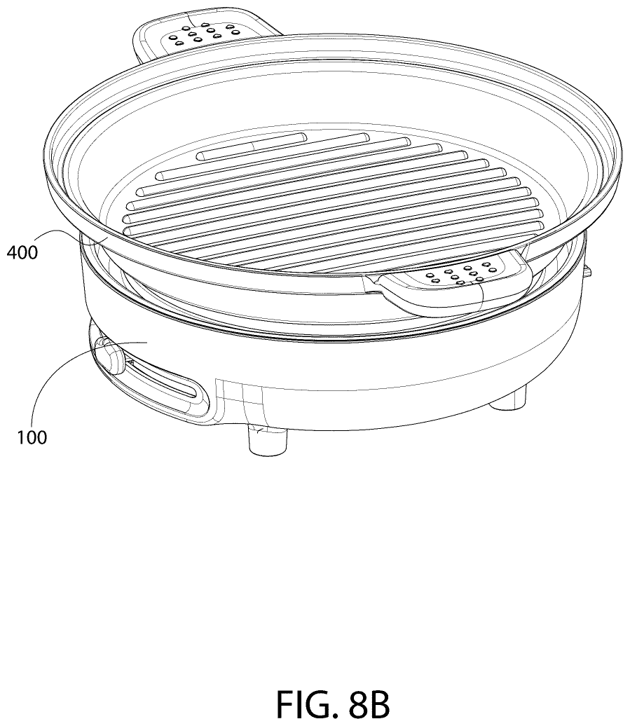

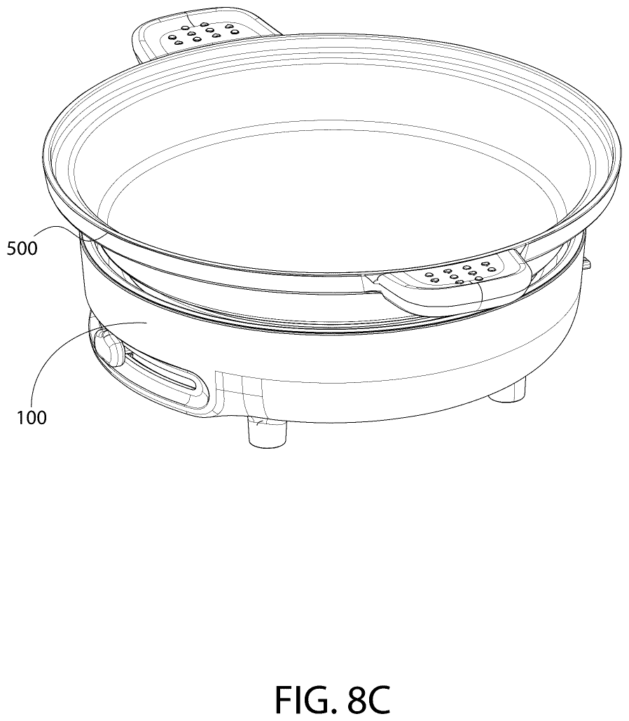

Referring sequentially to each of FIGS. 8A-8C, each of the remaining cooking vessels is illustrated in the cooking state such that the cooking vessel is placed atop of the cooking surface of the cooking unit 100. FIG. 8A illustrates the second cooking vessel 300 placed atop of the cooking plate 110 of the cooking unit 100. FIG. 8C illustrates the third cooking vessel 400 placed atop of the cooking plate 110 of the cooking unit 100. FIG. 8D illustrates the fourth cooking vessel 500 placed atop of the cooking plate 110 of the cooking unit 100. Depending on which cooking vessel a user desires to cook in, any of the cooking vessels 200, 300, 400, 500 may be placed onto the cooking surface of the cooking unit 100 to perform a cooking operation. When any one of the cooking vessels 200, 300, 400, 500 is placed onto the cooking surface of the cooking unit 100, the thermostat member 151 described above is altered from the extended state to the retracted state The mass or weight of each of the cooking vessels 200, 300, 400, 500 may be sufficient to overcome the bias or spring force of the spring member 152 to alter the thermostat member 151 into the unlocked state, as has been described in detail above.

Furthermore, it may be possible for a user to use an alternative cooking vessel (i.e., one that is not included as part of the cooking system 1000) with the cooking unit 100. As long as the cooking vessel fits onto the cooking surface of the cooking plate 110, it should be able to be used with the cooking unit 100 for cooking food therein or thereon. Furthermore, if the cooking vessel fits on the cooking surface of the cooking plate 110, the cooking vessel may also alter the thermostat member 151 from the extended state to the retracted state as described herein.

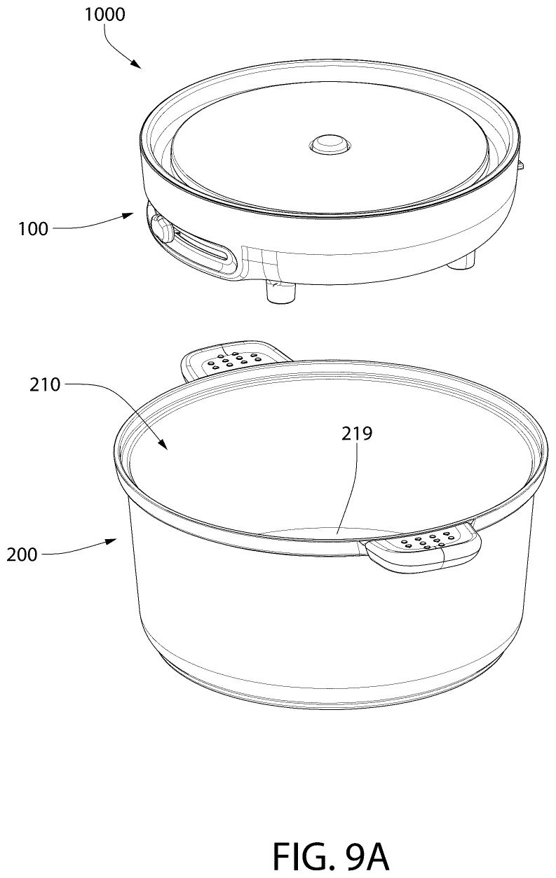

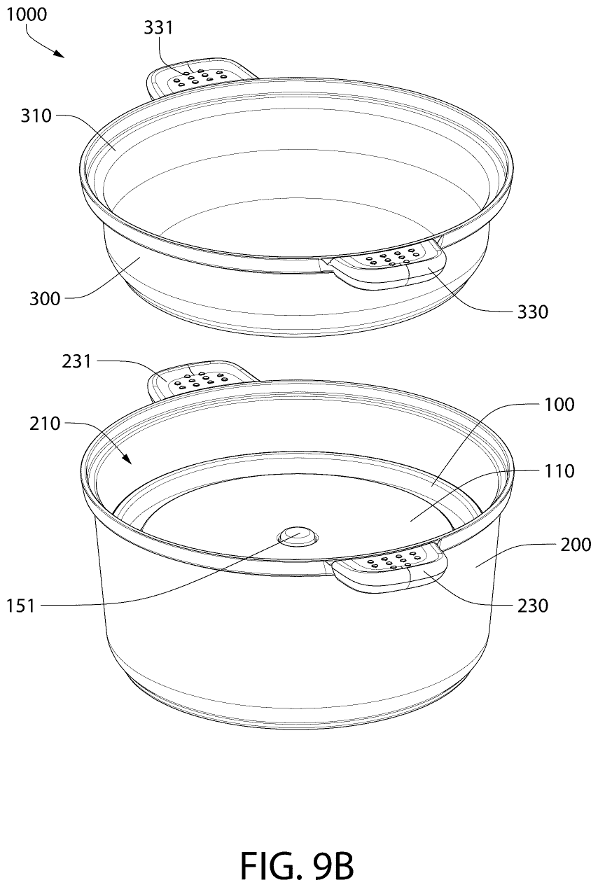

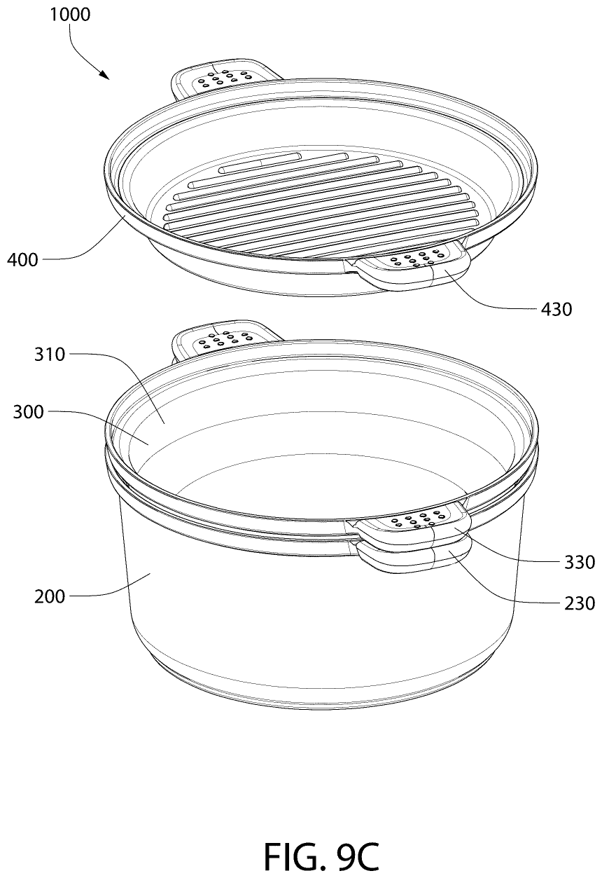

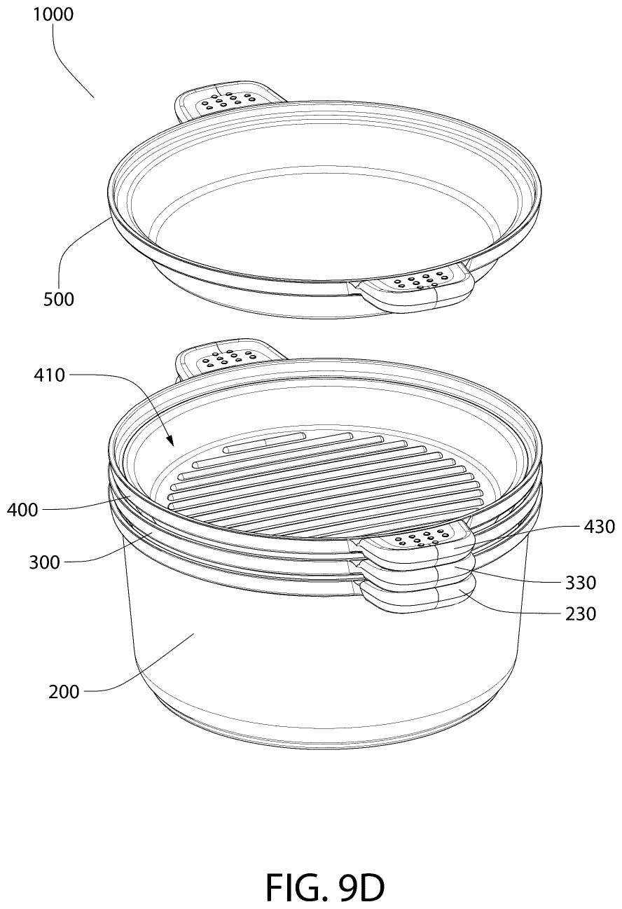

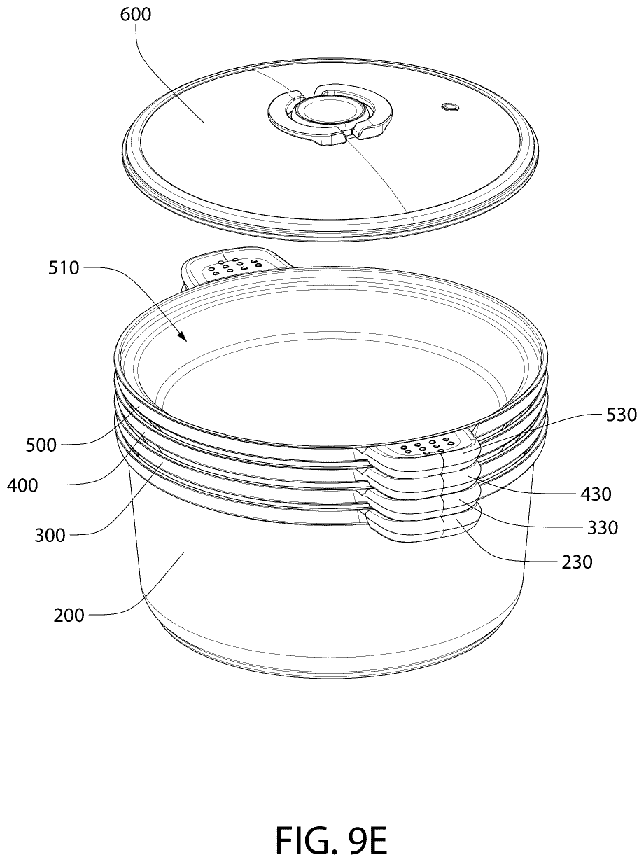

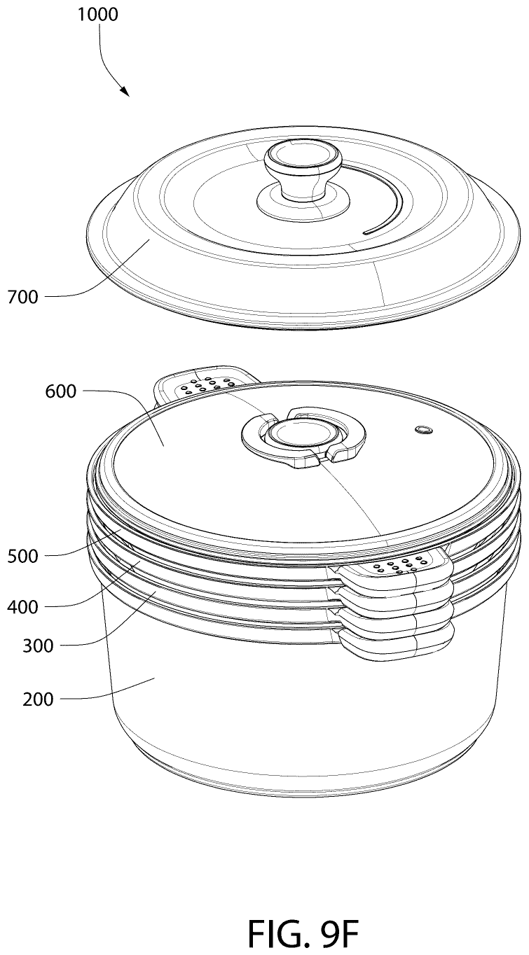

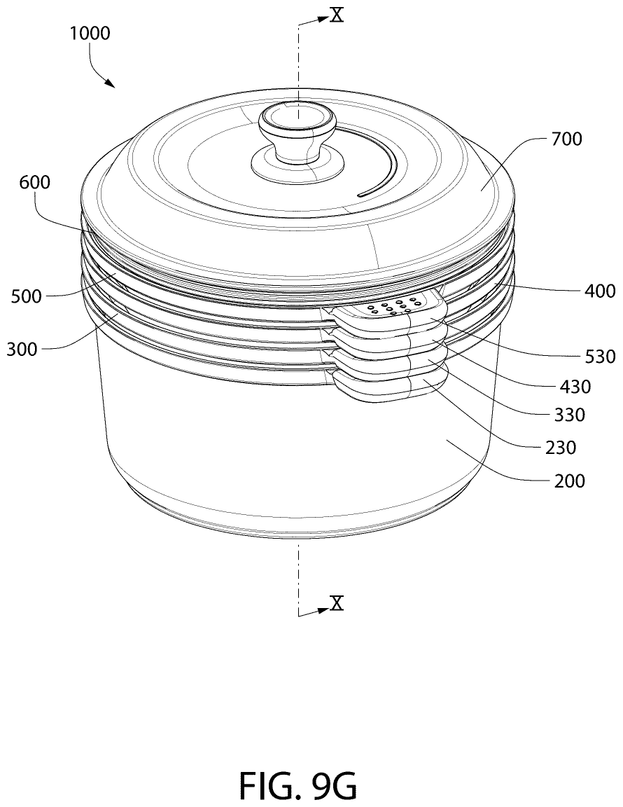

Referring sequentially to FIGS. 9A-9G, the process of stacking the cooking system 1000 into the storage state will be described. FIGS. 9A-9G will be described one-by-one, with reference being made simultaneously to FIG. 10 so that the end result of the stacking can be appreciated and viewed while considering the stacking steps.

Referring first to FIGS. 9A and 10, the cooking unit 100 is illustrated being inserted into the empty first cavity 210 of the first cooking vessel 200. When assembling the cooking system 1000 into the storage state, the first cooking vessel 200 serves as the outermost component into which the other components are placed one-by-one. The cooking unit 100 is the first component that is placed into the first cavity 210 of the first cooking vessel 200. In an embodiment, the first cooking vessel 200 may be placed into the first cavity 210 of the first cooking vessel 200 until the legs 107 of the cooking unit 100 contact the floor 219 of the first cavity 210. However, the invention is not to be so limited and the cooking unit 100 may be supported in the first cavity 210 of the first cooking vessel 200 without being positioned in contact with the floor 219 of the first cavity 210. For example, in an embodiment the inner surface of the first cooking vessel 200 may contact the outer surface of the cooking unit 100 to support the cooking unit 100 within the first cavity 210 in an elevated position relative to the floor 219 of the first cavity 210. However, in one embodiment, the preferred arrangement may be for the legs 107 of the cooking unit 100 to be in direct contact with the floor 219 of the first cavity 210.

In the exemplified embodiment, the cooking unit 100 is placed within the first cavity 210 of the first cooking vessel 200 with the legs 107 of the cooking unit 100 contacting the floor 219 of the first cooking vessel 200, but the remainder of the cooking unit 100 spaced from the first cooking vessel 200. In particular, the inner surface 222 of the body portion sidewall 221 of the first cooking vessel 200 may not contact the outer surface of the cooking unit housing 101. Thus, the cooking unit 100 may fit within the first cavity 210 of the first cooking vessel 200 with some clearance so that the exterior of the cooking unit 100 is not damaged during the insertion/removal process.

Referring to FIGS. 9B and 10, the cooking system 1000 is illustrated whereby the cooking unit 100 is located within the first cavity 210 of the first cooking vessel 200 and the second cooking vessel 300 is prepared to be inserted into the first cavity 210 of the first cooking vessel 200. The cooking unit 100 does not take up the entire volume of the first cavity 210 of the first cooking vessel 200. Rather, there is a good amount of space/volume above the top of the cooking unit 100 and between the cooking unit 100 and the top of the first cavity 210 within which the second cooking vessel 300 may be positioned when stacked in the storage state. The cooking unit 100 may take up approximately 30%-70% of the height of the first cavity 210 when the cooking unit 100 is positioned therein, leaving the remaining height of the first cavity 210 available to receive the second cooking vessel 300.

Referring to FIGS. 9C and 10, the cooking system is illustrated whereby the cooking unit 100 and the second cooking vessel 300 are located within the first cavity 210 of the first cooking vessel 200 and the third cooking vessel 400 is prepared to be inserted into the second cavity 310 of the second cooking vessel 300. When the second cooking vessel 300 is located within the first cavity 210 of the first cooking vessel 200, the first handle 330 of the second cooking vessel 300 nests within the handle depression of the first handle 230 of the first cooking vessel 300. Simultaneously, the second handle 331 of the second cooking vessel 300 nests within the handle depression of the second handle 231 of the second cooking vessel 200. Thus, the second cooking vessel 300 may be supported by the first cooking vessel 200 and not by the cooking unit 100.

In an embodiment, the second cooking vessel 300 comprises a bottom end 301, a top end 302, and a height H1 measured from the bottom end to the top end. In one embodiment, at least 70% of the height H1 of the second cooking vessel 300 is located within the first cavity 210 of the first cooking vessel 200 when in the storage state. In another embodiment, at least 75% or at least 80% of the height H1 of the second cooking vessel 300 is located within the first cavity 210 of the first cooking vessel 200 when in the storage state.

In an embodiment, the second cooking vessel 300 is supported by the first cooking vessel 200. Specifically, due to the first and second handles 330, 331 of the second cooking vessel 300 resting atop of the rim 224 and the first and second handles 230, 231 of the first cooking vessel 200, the second cooking vessel 300 is supported by the first cooking vessel 200. Due to the second cooking vessel 300 being supported by the first cooking vessel 200, in an embodiment the bottom end 301 of the second cooking vessel 300 is not in contact with the cooking plate 110 of the cooking unit 100. Instead, the second cooking vessel 300 is supported by the first cooking vessel 200 so that the bottom end 301 of the second cooking vessel 300 is maintained spaced apart from the top surface 111 (i.e., the cooking surface) of the cooking plate 110 of the cooking unit 100. In some embodiments, the bottom surface 301 of the second cooking vessel 300 may contact the top surface 154 of the thermostat member 151 of the cooking unit 100, although in other embodiments the bottom surface 301 of the second cooking vessel 300 may be spaced from the top surface 154 of the thermostat member 151 of the cooking unit 100 as well.

The bottom end 301 of the second cooking vessel 300 may be maintained spaced from the top surface 111 of the cooking plate 110. Thus, there may be a gap 99 existing between the top surface 111 of the cooking plate 110 and the bottom end 301 of the second cooking vessel 300 when the cooking unit 100 is located in the first cavity 210 of the first cooking vessel 200 and the second cooking vessel 300 is stacked in and supported by the first cooking vessel 200. The gap 99 may exist in the direction of the first cavity axis A-A. In the exemplified embodiment, this ensures that the second cooking vessel 300 does not alter the thermostat member 151 from the extended state in which it is biased into the retracted state. As discussed above, the thermostat member 151 is altered from the extended state to the retracted state by actuating the thermostat member 151 downwardly due to the weight of the cooking vessel being placed thereon. By maintaining a space between the second cooking vessel 300 and the cooking unit 100 when in the storage state, despite both of the second cooking vessel 300 and the cooking unit 100 being located at least partially within the first cavity 210 of the first cooking vessel 200, the thermostat member 151 remains in the extended state when the cooking system 1000 is in the storage state (stacked arrangement).

In an embodiment, the top surface 111 of the cooking plate 110 may be recessed relative to a top end 103 of the cooking unit housing 101. In an embodiment, when the cooking system 1000 is in the stacked state, a bottom portion of the second cooking vessel 300 may be located within the space defined between the top surface 111 of the cooking plate 110 and the top end 103 of the cooking unit housing 101.

When the second cooking vessel 300 and the cooking unit 100 are located within the first cavity 210 of the first cooking vessel 200, the cooking unit 100 is not visible from the outside. That is, a person viewing the cooking system 1000 when stacked in the storage state would not be able to see the cooking unit 100 due to it being hidden between the first and second cooking vessels 200, 300. This is apparent from FIGS. 9C and 10.

As noted, FIG. 9C illustrates the third cooking vessel 400 in preparation to be inserted into the second cavity 310 of the second cooking vessel 200. Referring to FIGS. 9D and 10, the third cooking vessel 400 is illustrated in the stacked arrangement of the storage state such that the third cooking vessel 400 is located within the second cavity 310 of the second cooking vessel 300. The third cooking vessel 400 is positioned so that the first handle 430 of the third cooking vessel 400 rests atop of the first handle 330 of the second cooking vessel 300 and the second handle 431 of the third cooking vessel 400 rests atop of the second handle 331 of the second cooking vessel 300. Thus, the handles 330, 331 and the top end of the rim 324 of the second cooking vessel 300 supports the third cooking vessel 400. A lower part of the third cooking vessel 400 may be located within the second cavity 310 of the second cooking vessel 300, while a bottom end 401 of the third coking vessel 400 may be spaced from a floor 399 of the second cavity 310 of the second cooking vessel 300. In an embodiment, a lower portion of the third cooking vessel 400 may extend into the first cavity 210 of the first cooking vessel 200 when in the storage state. That is, a horizontal plane HP1 may intersect the lower portion of the third cooking vessel 400, a portion of the second cooking vessel 300, and a portion of the first cavity 210 of the first cooking vessel 200.

FIG. 9D also illustrates the fourth cooking vessel 500 in preparation to be inserted into the third cavity 410 of the third cooking vessel 400.

Turning to FIG. 9E, the fourth cooking vessel 500 is supported by the third cooking vessel 400. Specifically, the handles 530, 531 of the fourth cooking vessel 500 rest atop of the handles 430, 431 (or nest within the top surface depressions thereof) of the third cooking vessel 400. The handles 530, 531 of the fourth cooking vessel 500 may also rest atop of a top end of the rim 424 of the third cooking vessel 400. The body of the fourth cooking vessel 500 then hangs downwardly within the third cavity 410 of the third cooking vessel 400. In an embodiment, the bottom end 501 of the fourth cooking vessel 500 is maintained spaced from the floor 499 of the third cavity 410 of the third cooking vessel 400.

Next, as shown in FIG. 9E, the first lid 600 is positioned atop of the fourth cooking vessel 500. The first lid 600 may close the open top end of the fourth cavity 510 of the fourth cooking vessel 500. Next, as shown in FIGS. 9F and 9G, the second lid 700 is placed atop of the first lid 600. The second lid 700 may define a lid cavity 710. The first lid 600 may nest within the lid cavity 710 of the second lid 700 when the first and second lids 600, 700 are included in the stacked arrangement of the cooking system 1000.

In an embodiment, the lid edge 602 of the first lid 600 that is formed from an elastomeric material may comprise an outer annular flange 609 having a top surface that is recessed below the top surface of the first lid 600. The second lid 700 may comprise a lower surface 702 and an annular protuberance 709 that protrudes from the lower surface 702. When the second lid 700 is stacked atop of the first lid 600, the annular protuberance 709 may nest in the space defined between the recessed outer annular flange 609 and the top surface of the first lid 600. This may serve to retain the second lid 700 securely atop the first lid 600 so that the second lid 700 does not readily slide off from the first lid 600 without user action. Furthermore, since the lid edge 602 of the first lid 600 is formed from an elastomeric material and the annular protuberance 709 of the second lid 700 is in contact with the lid edge 602 of the first lid 600, the elastomeric material may provide an anti-slip feature that helps to securely maintain the second lid 700 in place on the first lid 600.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

1. A cooking system comprising:
a cooking unit comprising a cooking surface;
a plurality of cooking vessels comprising:
a first cooking vessel comprising a first cavity having a first volume;
a second cooking vessel comprising a second cavity having a second volume that is less than the first volume;
wherein in a cooking state, any one of the plurality of cooking vessels is configured to be placed atop of the cooking surface of the cooking unit and heated by the cooking unit; and
wherein in a storage state, the cooking unit and the second cooking vessel are at least partially positioned within the first cavity of the first cooking vessel with the cooking unit located between the second cooking vessel and a floor of the first cavity of the first cooking vessel.

2. The cooking system according to claim 1 wherein the plurality of cooking vessels further comprises:
a third cooking vessel comprising a third cavity; and
a fourth cooking vessel comprising a fourth cavity;
wherein in the storage state the third cooking vessel is positioned within the second cavity of the second cooking vessel and the fourth cooking vessel is positioned within the third cavity of the third cooking vessel.

3. The cooking system according to claim 2 further comprising:
a lid;
wherein in the storage state the lid is positioned atop of the fourth cooking vessel.

4. The cooking system according to claim 2 further comprising:
a first lid formed from a glass; and
a second lid formed from a metal or a ceramic;
wherein in the storage state the first lid is configured to be positioned atop of the fourth cooking vessel to close a top opening of the fourth cavity and the second lid is configured to be positioned atop of an upper surface portion of the first lid.

5. The cooking system according to claim 4 wherein the first lid comprises a lid base formed from glass and a knob, the knob comprising a hub portion that is coupled to the lid base and comprises a top surface and at least one gripping member that is pivotably coupled to the base between a first position wherein no portion of the at least one gripping member protrudes beyond the top surface of the hub portion and a second position wherein at least a portion of the at least one gripping member protrudes above the top surface of the hub portion, and wherein in the storage state the at least one gripping member is in the first position and nests within a lid cavity defined by the second lid, wherein the at least one gripping member comprises a first gripping member and a second gripping member, each of the first and second gripping members being U-shaped and having an inner surface, wherein in the first position the inner surface of the first gripping member surrounds a first portion of a side surface of the hub portion and the inner surface of the second gripping member surrounds a second portion of the side surface of the hub portion, and wherein in the second position each of the first and second gripping members protrude above the top surface of the hub portion to define a space between the inner surfaces of the first and second gripping members and the top surface of the hub portion, and wherein the space is configured to receive a user's fingers to facilitate movement of the first lid.

6. The cooking system according to claim 2 wherein each of the first and second cooking vessels is a pot, and wherein each of the third and fourth cooking vessels is a pan.

7. The cooking system according to claim 2 wherein each of the first, second, third, and fourth cooking vessels comprises a first handle and a second handle that is circumferentially spaced apart from the first handle, and wherein in the storage state the first handle of each of the first, second, third, and fourth cooking vessels are stacked atop one another and the second handle of each of the first, second, third, and fourth cooking vessels are stacked atop one another.

8. The cooking system according to claim 1 wherein the cooking unit comprises a heating element that is configured to heat the cooking surface when activated.

9. The cooking system according to claim 1 wherein the second cooking vessel has a bottom end, a top end, and a height measured from the bottom end to the top end, and wherein at least 70% of the height of the second cooking vessel is located within the first cavity of the first cooking vessel when in the storage state.

10. The cooking system according to claim 9 wherein an entirety of the cooking unit is located within the first cavity of the first cooking vessel when in the storage state, and wherein the plurality of cooking vessels further comprises a third cooking vessel that is at least partially located within the second cavity of the second cooking vessel when in the storage state, and wherein a lower portion of the third cooking vessel extends into the first cavity of the first cooking vessel when in the storage state such that a horizontal plane intersects the lower portion of the third cooking vessel, a portion of the second cooking vessel, and a portion of the first cavity of the first cooking vessel.

11. The cooking system according to claim 1 wherein the first cooking vessel comprises:
a first cavity axis extending from the floor of the first cavity to a first opening of the first cavity;
a bottom portion comprising a bottom surface, a top surface that defines the floor of the first cavity, and a bottom portion sidewall;
a body portion comprising:
a body portion sidewall having an inner surface that bounds the first cavity and an outer surface, the outer surface being angled outwardly in a direction away from the first cavity axis; and
a rim extending from a top end of the body portion sidewall; and
a curved transition portion extending between the bottom portion and the body portion.

12. The cooking system according to claim 1 wherein the cooking unit further comprises:
a cooking unit housing comprising a cooking unit floor and a cooking unit sidewall that define a cooking unit cavity, the cooking unit sidewall having an inner surface that faces the cooking unit cavity;
a cooking plate that comprises the cooking surface located within the cooking unit cavity, the cooking plate comprising a peripheral surface that is spaced apart from the inner surface of the cooking unit sidewall by an annular gap;
wherein in the cooking state, a central portion of a bottom surface of the any one of the plurality of cooking vessels is in direct surface contact with the cooking surface of the cooking unit and an outer annular portion of the bottom surface of the any of the plurality of cooking vessels is located within the annular gap; and
wherein in the storage state, support legs of the cooking unit are in contact with the floor of the first cavity of the first cooking vessel and the bottom surface of the second cooking vessel is spaced apart from the cooking surface of the cooking unit.

13. The cooking system according to claim 1 further comprising:
the cooking unit comprising:
a cooking adjustment actuator alterable between an off state and one or more on states;
a thermostat member; and
a heating element operably coupled to the thermostat member;
wherein in the cooking state, the thermostat member is in surface contact with a bottom surface of the any of the plurality of cooking vessels to detect a temperature of the any one of the plurality of cooking vessels, and wherein an amount of heat generated by the heating element is adjusted based on the temperature detected by the thermostat member.

14. The cooking system according to claim 13 further comprising:
the cooking unit comprising:
a cooking plate comprising a top surface that forms the cooking surface, a bottom surface opposite the top surface, and a through-hole extending from the top surface to the bottom surface; and
the thermostat member located in the through-hole and operably coupled to a spring member that biases the thermostat member into an extended state whereby the thermostat member protrudes from the cooking surface of the cooking plate; and
wherein upon any one of the plurality of cooking vessels being placed onto the cooking surface of the cooking unit, a weight of the any one of the plurality of cooking vessels alters the thermostat member into a retracted state whereby a top surface of the thermostat member is flush with the cooking surface of the cooking plate.

15. The cooking system according to claim 14 wherein when the cooking system is in the storage state, the weight of the second cooking vessel is supported by the first cooking vessel and the thermostat member remains in the extended state, and wherein positioning any one of the plurality of cooking vessels onto the cooking surface of the cooking unit alters the thermostat member from the extended state to the retracted state.

16. The cooking system according to claim 1 further comprising:
the cooking unit comprising:
a cooking plate that comprises the cooking surface; and
a thermostat member that is located within an opening in the cooking plate, wherein the thermostat member is alterable between an extended state wherein at least a portion of the thermostat member protrudes from the cooking surface of the cooking plate and a retracted state wherein a top surface of the thermostat member is flush with the cooking surface of the cooking plate, and wherein the thermostat member is biased into the extended state by a spring member and is altered into the retracted state when any of the plurality of cooking vessels is located atop of the cooking surface; and
wherein when the cooking system is in the storage state, a bottom end of the second cooking vessel is maintained spaced from the cooking surface of the cooking unit and the thermostat member is in the extended state.

17. The cooking system according to claim 1 wherein in the storage state the second cooking vessel is supported by the first cooking vessel so that a bottom end of the second cooking vessel is elevated above and spaced from the cooking surface of the cooking unit.

18. A cooking system comprising:
a cooking unit comprising a cooking surface;
a plurality of cooking vessels comprising:
a first cooking vessel comprising a first cavity;
a second cooking vessel comprising a second cavity; and
a third cooking vessel comprising a third cavity;
wherein the cooking system is alterable between a storage state and a cooking state;
wherein in the storage state, the cooking unit and the plurality of cooking vessels are in a stacked arrangement whereby the cooking unit is located entirely within the first cavity of the first cooking unit, the second cooking vessel is supported by the first cooking vessel with at least a majority of the second cooking vessel located within the first cavity of the first cooking vessel, and the third cooking vessel is supported by the second cooking vessel and is at least partially positioned within the second cavity of the second cooking unit; and
wherein in the cooking state, the cooking unit is positioned atop of a support surface and any one of the plurality of cooking vessels is positioned atop of the cooking surface of the cooking unit for heating by the heating unit.

19. The cooking system according to claim 18 further comprising:
the cooking unit comprising:
a cooking adjustment actuator alterable between an off state and one or more on states;
a thermostat member; and
a heating element operably coupled to the thermostat member;
wherein in the cooking state, the thermostat member is in surface contact with a bottom surface of the any of the plurality of cooking vessels to detect a temperature of the any one of the plurality of cooking vessels, and wherein an amount of heat generated by the heating element is adjusted based on the temperature detected by the thermostat member; and
wherein in the storage state a bottom end of the second cooking vessel is maintained spaced apart from the cooking surface of the cooking unit.

20. A cooking system comprising:
a cooking unit comprising:
a cooking plate comprising a cooking surface and a through-hole; and
a thermostat member that is located within the through-hole of the cooking plate, the thermostat member being alterable between an extended state wherein at least a portion of the thermostat member protrudes from the cooking surface of the cooking plate and a retracted state wherein a top surface of the thermostat member is flush with the cooking surface of the cooking plate, wherein the thermostat member is biased into the extended state by a spring member;
a plurality of cooking vessels comprising:
a first cooking vessel comprising a first cavity; and
a second cooking vessel;
wherein in a storage state, the cooking unit and the second cooking vessel are at least partially positioned within the first cavity of the first cooking vessel with the cooking unit located between the second cooking vessel and a floor of the first cavity of the first cooking vessel, a bottom surface of the cooking vessel being maintained spaced from the cooking surface of the cooking unit, and the thermostat member being in the extended state; and
wherein in a cooking state, any one of the plurality of cooking vessels is configured to be placed atop of the cooking surface of the cooking unit, thereby altering the thermostat member from the extended state to the retracted state.
